(19) United States
(12) Patent Application Publication
(10) Pub. No.: US 2005/0192050 A1
(43) Pub. Date: Sep. 1, 2005

(54) Method and apparatus for processing incoming call of wireless telephone having camera

(75) Inventors: Jae-Gon Son, Buk-gu (KR); Kang-Wook Kim, Buk-gu (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/017,864

(22) Filed: Dec. 22, 2004

(30) Foreign Application Priority Data
Dec. 22, 2003 (KR) 2003-94564

(51) Int. Cl. H04N 1/32; H04M 1/00; H04B 1/38

(52) U.S. Cl. 455/556.1; 455/567

(57) ABSTRACT

Disclosed is a method and apparatus for processing an incoming call of a wireless telephone having a camera. The method for processing an incoming call comprises the steps of storing an image photographed by the camera in an image storage mode, generating a soundless alarm with respect to the generation of the incoming call when the incoming call is generated in an image photographing mode and maintaining the image storage mode, generating a message that a response to the incoming call cannot be performed when an incoming call holding command is issued in the step of generating the soundless alarm, terminating an incoming call processing, and maintaining the image storage mode, and guiding input of a name of a stored image file when a record termination command is issued in the image storage mode and storing the file name with the stored image file after the file name is input.

### PRIORITY

This application claims the benefit under 35 U.S.C. §119(a) of an application entitled “Method for Processing Incoming Call of Wireless Telephone Having Camera” filed in the Korean Intellectual Property Office on Dec. 22, 2003 and assigned Serial No. 2003-94564, the entire contents of which are incorporated herein by reference.

### BACKGROUND OF THE INVENTION

1. Field of the Invention

The present invention relates to a method and apparatus for processing an incoming call in a portable terminal. More particularly, the present invention relates to a method and apparatus capable of processing an incoming call while photographing an image.

2. Description of the Related Art

Generally, an image processing device includes a camera for photographing an image and a display unit for displaying the image photographed by the camera. Herein, the camera may employ a charge coupled device (CCD) or a CMOS sensor. Also, the display unit may employ a liquid crystal display (LCD). The size of photography devices is becoming more compact and therefore commensurate with the compact size of digital cameras. In addition, currently, many digital cameras having a compact size are widely used. Such photography devices tend to be installed in portable terminals. The portable terminal photographs the image and can display the photographed image as a moving picture or a still picture. Also, the portable terminal can transmit the photographed image to a base station.

When receiving an incoming call while the image is being photographed, the portable terminal stops photographing and processes the incoming call. In this case, the portable terminal may lose information regarding the image being photographed can be stored. Also, the incoming call can be disconnected while a user is inputting a file name of an image being stored in a store mode so as to store information about the image being photographed. Also, if the user continues photographing an image while ignoring the incoming call received during the image photographing, the ring-tone sound (bell or music) for the incoming call can be stored with the image. In addition, when the incoming call is received in a vibration mode, the photographed image may shake due to vibration of the portable terminal or the user may drop the portable terminal. At this time, the other-side subscriber who have originated the call cannot know the state of the call-termination side and may originate a call again so as to disturb the photographing by the user of the call-termination side.

### SUMMARY OF THE INVENTION

Accordingly, the present invention has been made to solve the above-mentioned problems occurring in the prior art, and an object of the present invention is to provide a method in which an incoming call generated while an image is being photographed can be selectively processed in a portable terminal including a camera.

Another object of the present invention is to provide a method in which a portable terminal having a camera can stably photograph an image while informing a caller call that the photographing of the image is in progress when an incoming call is generated during the photographing.

Still another object of the present invention is to provide a method in which, an incoming call generated while an image is being photographed is processed and the image photographing is temporarily stopped, and the image is then continuously photographed after the processing or the incoming call in a portable terminal including a camera.

Yet another object of the present invention is to provide a method in which, an incoming call generated while an image is being photographed can be processed and information about the photographed image can be stored when the incoming call is ended in a portable terminal including a camera.

Still another object of the present invention is to provide a method in which an incoming call can be received in a soundless alarm mode during the photographing of an image in a portable terminal including a camera.

To accomplish the above objects, there is provided a method for processing an incoming call in a portable terminal including a camera, the method comprising the steps of storing an image photographed by the camera in an image storage mode, generating a soundless alarm with respect to the generation of the incoming call when the incoming call is generated in an image photographing mode and maintaining the image storage mode, generating a guide message that a response to the incoming call cannot be performed when an incoming call holding command is issued in the step of generating the soundless alarm, terminating an incoming call processing, and maintaining the image storage mode, and controlling an input of a name of a stored image file when a record termination command is issued in the image storage mode and storing the file name with the stored image file after the file name is input.

### BRIEF DESCRIPTION OF THE DRAWINGS

The above and other objects, features and advantages of the present invention will be more apparent from the following detailed description taken in conjunction with the accompanying drawings, in which:

FIG. 1 is a block diagram showing a structure of a portable terminal including a camera according to an embodiment of the present invention;

FIG. 2 is a block diagram showing a structure of an image processing unit shown in FIG. 1;

FIG. 3 is a flowchart showing a procedure of processing an incoming call and photographing an image in a portable terminal according to an embodiment of the present invention; and

FIG. 4 is a flowchart showing a procedure of processing an incoming call shown in FIG. 3.

Note that the same or similar components, features and structures in the drawings are designated by the same reference numerals as far as possible although they are shown in different drawings.

### DETAILED DESCRIPTION OF EXEMPLARY EMBODIMENTS

Hereinafter, preferred embodiments of the present invention will be described in detail with reference to the accompanying drawings. In the following description of embodiments of the present invention, a detailed description of known functions and configurations incorporated herein will be omitted for the sake of clarity.

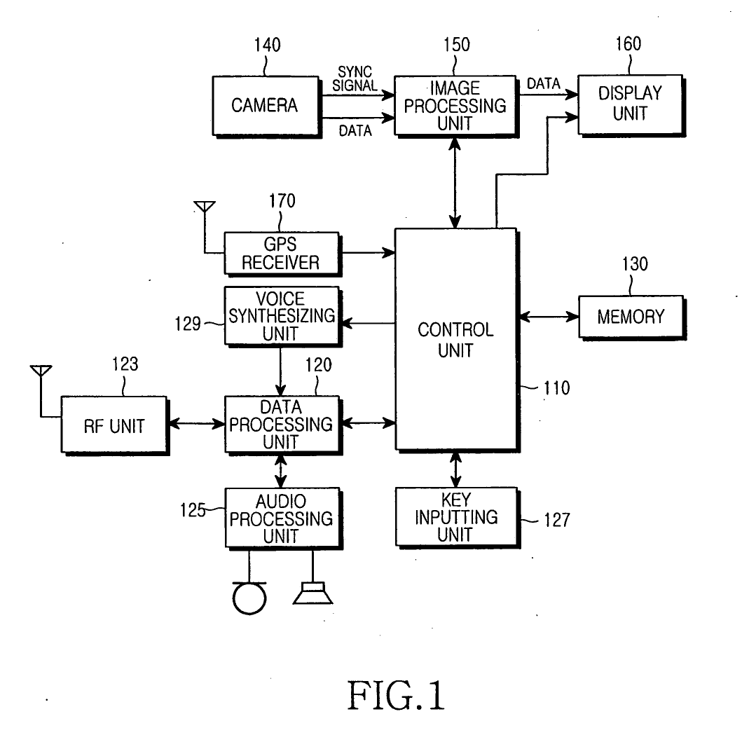

FIG. 1 is a block diagram showing a structure of a portable terminal according to an embodiment of the present invention. Also, the structure of the portable terminal may be a structure of a wireless telephone.

An RF unit 123 performs a wireless communication function of the wireless telephone. The RF unit 123 includes an RF transmitter which up-converts and amplifies a frequency of a transmitted signal and an RF receiver which low-noise amplifies a received signal and down-converts a frequency of the received signal. A data processing unit 120 includes a transmitter for encoding and modulating the transmitted signal and a receiver for demodulating and decoding the received signal. That is, the data processing unit 120 may include an MODEM and a CODEC. Herein, the CODEC includes a data CODEC for processing packet data, etc., and an audio CODEC for processing audio signals such as voices. An audio processing unit 125 reproduces an audio signal transmitted from the audio CODEC of the data processing unit 120 or sends an audio signal transmitted from a microphone to the audio CODEC of the data processing unit 120. A voice synthesizing unit 129 converts a guide message, which informs the caller that a moving picture is being photographed when an incoming call is generated during the photographing of the moving picture, into a voice signal.

A key inputting unit 127 includes keys for inputting numeral and other information and function keys for setting a variety of functions. Also, the key inputting unit 127 may include a photographing key for operating the camera and function keys for controlling a moving picture mode according to an embodiment of the present invention.

A memory 130 may include a program memory, a data memory, and moving picture memories for storing image signals created and received according to one embodiment of the present invention. The program memory stores programs for call processing and image photography of the portable terminal, such as a wireless telephone. Also, the program memory stores a program for processing an incoming call during the photographing of an image according to an embodiment of the present invention. The data memory temporarily stores the data generated during the execution of the programs.

A control unit 110 controls the overall operation of the wireless telephone. Also, the control unit 110 may include the data processing unit 120. That is, the wireless telephone may have one chip, such as, an MSM chip, into which the control unit 110, the data processing unit 120, the audio processing unit 125, and the voice synthesizing unit 127 are integrated. The control unit 110 can set a voice guide mode for an incoming call according to an embodiment of the present invention. Also, the control unit 110 triggers a soundless alarm for the incoming call in an incoming mode. When the voice guide mode for the incoming call has been set, the control unit 110 transmits a previously recorded guide message and can end the processing of an incoming call.

A camera 140 includes a camera sensor for converting an optical signal detected when photographing an image into an electrical signal and a signal processing unit for converting the analog photographed image signal from the camera sensor into digital data. Herein, it is assumed that the camera sensor preferably includes a charged coupled device (CCD) sensor, and the signal processing unit can be realized by a digital signal processor (DSP). The camera sensor can be realized integrally with or separately from the signal processing unit.

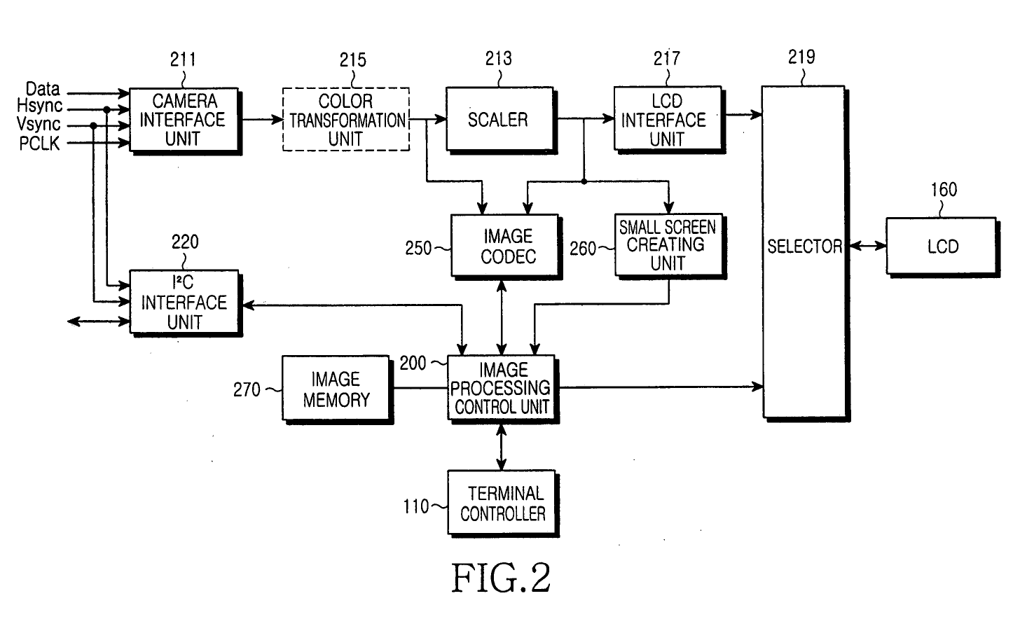

An image processing unit 150 generates screen data for displaying an image output from the camera 140. The image processing unit 150 processes the image output from the camera 140 in frames. The image processing unit 150 outputs the screen data suitably for the size and the characteristic of a display unit 160. Also, the image processing unit 150 includes an image CODEC 250, shown in FIG. 2. The image CODEC 250 codes the image through a predetermined method or decodes coded frame image data into original frame image data. Herein, the image CODEC 250 may include a JPEG CODEC and (or) an MPEG CODEC.

The display unit 160 displays the image signal output from the image processing unit 160 on a display screen. Also, the display unit 160 displays user data output from the control unit 110 on a display screen. Herein, the display unit 160 may employ an LCD. In this case, the display unit 160 may include an LCD controller, a memory capable of storing image data, and an LCD display element. Herein, when the LCD is embodied through a touch screen method, the display unit 160 may operate as an input unit.

A global positioning system receiver (GPS receiver) 170 receives GPS information from a GPS satellite and transmits the GPS information to the control unit 110. Herein, the GPS information may include current position information of the wireless telephone. According to an embodiment of the present invention, the wireless telephone can receive position (place) information and time information, in which a current moving picture is acquired, through the GPS receiver.

Referring to FIG. 1, when a user carries out dialing by means of the key inputting unit 127 in origination of an outgoing call, the control unit 110 detects the dialing and processes dial information received through the data processing unit 120. Then, the control unit 110 converts the dial information into an RF signal through the RF unit 123. After that, when a subscriber of the other party responds to the outgoing call, the control unit 110 detects the response of the other party through the RF unit 123 and the data processing unit 120. Then the control unit 110 performs a communication function by making up a channel formed through the RF unit 123, the data processing unit 120, and the audio processing unit 125.

In receiving of an incoming call, the control unit 110 detects an incoming call request through the data processing unit 120 and raises an alarm for the incoming call. At this time, if the wireless telephone is in an image photographing mode, the control unit 110 displays information regarding a subscriber having originated the call on the display unit 160 and raises an alarm for the generation of the incoming call by lighting a lamp. Herein, the soundless alarm for the incoming call as described above is necessary because the soundless alarm for the incoming call can prevent the recording of a ring-tone sound for the incoming call generated during the photographing of an image and because the soundless alarm can prevent blurring of an image being photographed, while in the vibration mode of the wireless telephone. Also, if a guide function in the middle of an image photographing has been set, the control unit 110 may output a voice signal, which informs the originating call side that the called side cannot respond to the incoming call, through the voice synthesizing unit 129.

Also, if the user presses a speech key in a state in which the incoming call is generated, the control unit 110 stops photographing the image and processes the incoming call. If the incoming call processing is finished, the control unit 110 changes into a preview mode and displays the previously photographed image. If the user performs a recording mode, a current image being photographed is stored subsequently to the previously photographed image. If image recording is finished, information about the photographed image is stored with a file name input by the user.

As described above, according to embodiments of the present invention, the wireless telephone photographs persons or surroundings and can display photographed images on an image screen or transfer the photographed images. The camera 140 may be installed in the wireless telephone or connected to an external predetermined part of the wireless telephone. That is, the camera 140 may be an imbedded camera or an external camera. The camera 140 may include a sensor for photographing an image and a signal processing unit for converting the image photographed by the sensor into digital data. The sensor may employ a CMOS sensor or a charged coupled device (CCD) sensor. The image photographed by the camera 140 is converted into an electrical signal in the internal sensor, and then, the electrical signal is converted into a digital image signal in the signal processing unit. Also, the converted digital image signal and sync signals are output to the image processing unit 150. Herein, the sync signals may include a horizontal synchronization signal (Hsync) and a vertical synchronization signal (Vsync).

The image processing unit 150 interfaces between the camera 140 and the display unit 160 in relation to an image signal and codes or decodes the image signal input from the camera 140. Also, the image processing unit 150 creates a small screen by performing cropping and decimation with respect to the coded image data pixels and the coded image data lines of a main screen. As described above, the image processing unit 150 comprises an image CODEC 250 for coding or decoding an image signal. Hereinafter, according to an embodiment of the present invention, the image CODEC 250 will be described on the assumption that the image CODEC 250 includes an MPEG CODEC. FIG. 2 is a block diagram showing an example of a structure of the image processing unit 150 according to an embodiment of the present invention.

Referring to FIG. 2, a camera interface unit 211 performs an interface function in relation to image data output from the camera 140. According to an embodiment of the present invention, it is assumed that the image data output from the camera 140 has a YUV format, and image data output from the display unit 160 has a RGB format.

A scaler 213 scales an image photographed by the camera 140 according to a control signal output from the control unit 110 such that the photographed image can be displayed on the display unit 160. That is, the scaler 213 either crops the image output from the camera 140 so as to make an image which can be displayed on the display unit 160 or reduces pixels of the image output from the camera 140 to the number of pixels of the image which can be displayed on the display unit 160. In contrast, if the display unit 160 displays an image larger than the image output from the camera 140, the scaler 213 can be designed in such a manner that the image output from the camera 140 can be enlarged and displayed under the control of the control unit 110. In the method for enlarging the image, pixels of an image which can be displayed on the display unit 160 are selected from among pixels of the image output from the camera 140.

A color transformation unit 215 transforms YUV data output from the scaler 213 into RGB data. Herein, if the camera 140 can generate photographed image data having a RGB format, or the display unit 160 can display image data having a YUV format, the color transformation unit 215 can be omitted.

Also, an LCD interface unit 217 interfaces with the display unit 160 in relation to image data. The LCD interface unit 217 includes a buffer accommodated therein in order to buffer the image data interfaced between the display unit 160 and LCD interface unit 217.

An image CODEC 250 can code the photographed image or decode the coded image under the control of an image processing control unit 200. According to an embodiment of the present invention, it is assumed that the image CODEC 250 includes an MPEG CODEC. The image CODEC 250 receives and MPEG-codes a camera image signal output from the color transformation unit 215 or an image signal displayed on the display unit 160 under the control of the image processing control unit 200. Also, the image CODEC 250 decodes the MPEG-coded image signal and outputs the decoded signal to the scaler 213 or the LCD interface unit 217. That is, the image CODEC 250 can code and decode the camera image and the displayed image.

The image processing control unit 200 controls an overall operation of the image processing unit 150. That is, the image processing control unit 200 controls an overall operation regarding display of an image photographed by the camera 140 by controlling the display unit 160 in an image photographing mode.

Herein, the image processing control unit 200 can process key data input from the key inputting unit 127 when processing the image. According to an embodiment of the present invention, the terminal control unit 110 checks key inputs generated from the key inputting unit 127. If the key inputs are key data relating to image processing, the terminal control unit 110 delivers the key inputs to the image processing control unit 200 such that the image processing control unit 200 issues a command for image processing. An image memory 270 stores photographed image information under the control of the image processing control unit 200.

A selection unit 219 outputs data generated during a call or user data under the control of the terminal control unit 110 in a waiting mode or a communication mode. Also, the selection unit 219 outputs a photographed image or a stored image to the display unit 160 under the control of the image processing control unit 200 in an image photographing mode or a display mode.

Referring to FIG. 2, the control unit 110 takes over control authority for the image processing from the image processing control unit 200. Then, the image processing control unit 200 displays user data delivered from the control unit 110 on the display unit 160. In addition, the image processing unit 200 controls the operation of displaying the image photographed by the camera 140 on the display unit 160 and an operation of storing the photographed image according to a user command in the image memory 270. That is, the control unit 110 controls operations relating to communication with the user regarding the photographed image. Also, the control unit 110 controls an operation of the display unit 160 only in a case of performing communication functions. If an operation of the camera 140 is selected, the image processing control unit 200 controls the overall operation of the wireless telephone.

In an operation of transferring an image acquired from the camera 140 to the display unit 160, the image processing unit 200 stores the image photographed by the camera 140 in a memory of the display unit 160 through the LCD interface 217. Herein, the size of image data in one frame, which is generated from the camera 140, can be different from the number of pixels of image data in one frame, which can be displayed in the display unit 160. Accordingly, the scaler 213 of the image processing unit 50 can remove a portion of the pixels of the image output from the camera 140 or can select and zoom in on a portion of the pixels of the image such that the image output from the camera 140 can be displayed on the display unit 160.

Also, when the image photographed by the camera 140 is displayed on the display unit 160 as a moving picture, a user can store the displayed image. That is, the user can store the displayed image by using the photographing key of the key inputting unit 127. At this time, if a photographing command is issued, the image processing control unit 200 codes the image data photographed in the camera 140 by controlling the image CODEC 250 and stores the coded data in the image memory 270.

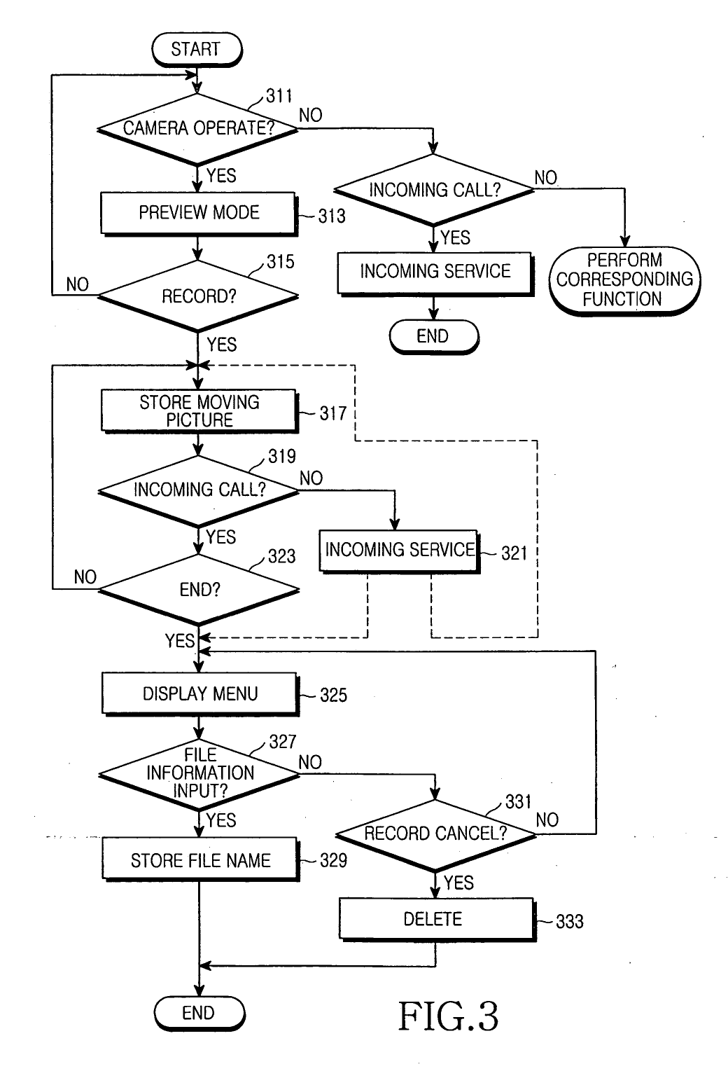

FIG. 3 is a flowchart showing a procedure of processing an incoming call when the incoming call is generated in the image photographing mode according to an embodiment of the present invention.

An image can be photographed by performing the preview mode after operating the camera or upon operating the camera. If a user presses the camera key, the control unit 110 detects the pressing of the camera key and informs the image processing control unit 200 of the fact that the camera key is pressed. The image processing control unit 200 detects the pressing of the camera key in step 311 and performs the preview mode by operating the camera 140 in step 313. The image processing control unit 200 displays the image photographed by the camera 140 in the preview mode. At this time, the color transformation unit 215 transforms the YUV image photographed by the camera 140 into a RGB image, and the scaler 213 scales the image of the camera 140 suitably for the size of the display unit 160 and applies the scaled image to the display unit 160. As a result, the image photographed by the camera 140 is displayed on the display unit 160 as a moving picture.

If a record key for storing the photographed image in the preview mode described above is pressed, the control unit 110 informs the image processing control unit 200 of the fact that the record key is pressed. The image processing control unit 200 detects seffing, up of a record mode in step 315. Then, the image processing control unit 200 MPEG-codes the image output from the color transformation unit 215 by controlling the image CODEC 250 and stores an MPEG-coded moving picture in the image memory 270 in step 317. Herein, since the image CODEC 250 includes an MPEG CODEC, an image in a first frame is compressed and coded as an I-frame image, and next frames are coded according to motion of a moving picture. Accordingly, if a moving picture photographing key is pressed in the preview mode, the image processing unit 200 MPEG-codes a moving picture photographed in the camera 140 and stores the coded moving picture in the image memory 270.

The control unit 110 determines whether or not a key input of the key inputting unit 127 or an incoming call is received while the image is being photographed and stored as described above. At this time, if neither the incoming call nor the key input is generated, the control unit 110 maintains the waiting mode, and the image processing control unit 200 stores the photographed image in step 317.

At this time, if a user presses a record terminating key in the image photographing mode, the control unit 110 informs the image processing control unit 200 of the fact that the record terminating key is pressed. The image processing control unit 200 detects the occurrence of the record terminating key in step 323. Then, the image processing control unit 200 stops the operation of the image CODEC 250 and displays menu information for registering a file name of the image stored in the image memory 270 in step 325. At this time, if the wireless telephone has no GPS receiver 170, the image processing control unit 200 can display a menu for inputting a file name of a moving picture stored in the image memory 270, and a time and a place in which the moving picture has been photographed If the wireless telephone includes the GPS receiver 170, a menu for inputting the file name of the moving picture stored in the image memory 270 can be displayed. The menu information can be created by the image processing control unit 200 or the control unit 110 and the created information is displayed on the display unit 160 as user data.

If the image file name is input through the key inputting unit 127 while the menu is being displayed as described above, the image processing control unit 200 detects the input of the image file name in step 327. In step 329, the image processing unit 200 stores a photographing place, a photographing time, and the name corresponding to the stored image file in the memory 270. At this time, a user can input only the name without inputting the photographing place and the photographing time. In this case, if the user presses an end key after inputting the name, the image processing control unit 200 registers only the name through information input in the menu due to the pressing of the end key.

Also, if the user issues a command for deleting a record while the input of the image file name is being guided in step 325, the image processing control unit 200 detects the occurrence of the command in step 331 and deletes the image file stored in the image memory 270 in step 333.

However, if an incoming call is generated while the image processing control unit 200 is storing the photographed image in step 317, the control unit 110 detects the generation of the incoming call in step 319 and processes an incoming call in step 321. At this time, in the processing of the incoming call, the wireless telephone may either inform the side having originated the call of the fact that an image is being photographed and continuously perform the image photographing mode, or process the incoming call during the photographing of the image. Further, in order to process the incoming call during the photographing of the image, the image processing control unit 200 may either return to the image photographing mode after processing the incoming call and store a currently-photographed image subsequently to the previously-photographed image or terminate photographing after inputting a file name for a currently-photographed image. Through the former method, a pre-existing image file before the incoming call processing is combined with an image file after the incoming call processing as one image file, and through the later method, the pre-existing image file before the incoming call processing and the image file after the incoming call processing are separated image files having different file names.

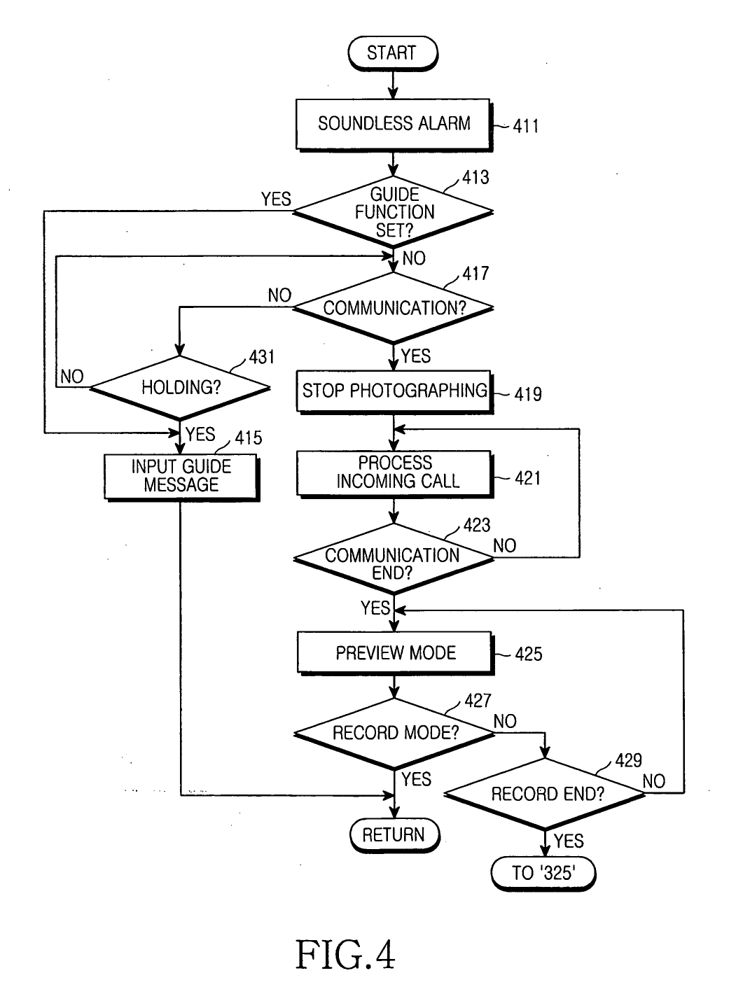

FIG. 4 is a flowchart showing a procedure of processing the incoming call in the image photographing mode according to an embodiment of the present invention.

If the incoming call is generated in the image photographing mode, the control unit 110 generates a soundless alarm and displays received information regarding the side originating the call on the display unit 160 in step 411. Herein, the soundless alarm may be generated by lighting the lamp or by lighting information about the side originating the call displayed on the display unit 160 may be employed. As described above, the soundless alarm is necessary because the soundless alarm does not influence the image and audio currently being photographed and recorded, respectively. In other words, a ring function for the incoming call influences the recorded audio for an image being currently photographed and recorded, and an incoming vibration alarm vibrates the wireless telephone to influence the image currently being photographed. Herein, the incoming call can be generated by using a voice, a message (SMS, EMS, and MMS), data, and the like.

In the soundless alarm state, the control unit 110 determines whether or not the guide function is set in step 413. Herein, the guide function in the middle of the photographing is a function indicating that it is difficult for the called side to communicate with the side originating the call when the incoming call is generated during the photographing of an image. That is, a user previously stores the guide message in the memory 130 and can set up the guide function in the image photographing mode. At this time, the control unit 110 detects the setting up of the guide function in step 413 and outputs voice data stored in the memory 130 to the voice synthesizing unit 129 in step 415. The voice synthesizing unit 129 sends the voice data to the side having originated the call through the data processing unit 120 and the RF unit 123 by converting the voice data into a voice signal. Then, the control unit 110 finishes processing the incoming call. When the incoming call is handled as described above, the image processing control unit 200 can continuously perform operations relating to image photographing. That is, if a function of rejecting the incoming call during the photographing of the image as described above is set, the control unit 110 does not inform the image processing control unit 200 of the generation of the incoming call and automatically sends to the side originating the call the guide message stored in the memory 130 indicating that the incoming call cannot be processed. Then, the control unit 110 stops processing the incoming call. Therefore, the image processing control unit 200 can continuously perform operations relating to photographing images in step 317.

However, if the guide function is not set, the control unit 110 determinates whether or not the speech key is input the soundless alarm state. If the user does not set the guide function before photographing an image, the user can set the guide function in the soundless alarm state. In this case, if the user presses an incoming call holding key in the soundless alarm state, the control unit 110 detects the pressing of the incoming call holding key in step 431. Then, the control unit 110 creates a message indicating that it is difficult for the called side to communicate with the side having originated the call and sends the message to the side having originated the call in step 415 and returns. Also, if the functions for communication are in an off state over a predetermined time in the soundless alarm state (that is, a speech button is not pressed, or the like), the control unit 110 regards the off state as an incoming call holding state. That is, if the user presses the incoming call holding key or does not respond to the incoming call over a predetermined time when the incoming call is generated in the camera photographing mode, the control unit 110 regards this as the incoming call holding state in step 431 and outputs to the subscriber having originated the call the guide message indicating that it is difficult for the called subscriber to respond to the incoming call in step 415. Similarly, the image processing control unit 200 continuously performs the operations relating to the image photographing in step 317.

However, if the speech key is input in the soundless alarm state, the control unit 110 detects an input of the speech key and informs the image processing control unit 200 of the fact that the incoming call is generated. In step 419, the image processing control unit 200 temporarily stops photographing an image by controlling the camera 140 and the image CODEC 250. That is, if the image processing control unit 200 detects the generation of the incoming call in the image photographing mode, the image processing control unit 200 is out of the preview mode by stopping the operation of the camera 140 in step 419 and stops storing an image in the image memory 270 by stopping the operation of the image CODEC. Thereafter, the control unit 110 processes the incoming call in step 421. Herein, processing of the incoming call continues until a speech end key for terminating communication between the called side and the side originating the call is input in step 423.

If the incoming call processing is terminated, there may be a method in which the image photographing mode is terminated and a file of an image having been photographed is stored or a method in which the image photographing mode is re-performed and a newly photographed image is stored subsequently to the image having been photographed. Through the former method, if the control unit 110 detects the communication termination in step 423, the control unit 110 registers a file name of the stored image having been photographed and the image photographing mode is terminated in step 325 shown in FIG. 3.

Hereinafter, according to an embodiment of the present invention, a case of employing the later method when a photographing is temporarily stopped in the image photographing mode will be described. Through the later method, if the communication is terminated in the middle of servicing the incoming call, the control unit 110 detects the communication termination in step 423 and informs the image processing control unit 200 of the fact of the communication termination. In step 425, the image processing control unit 200 performs the preview mode by operating the camera 140. If the record mode occurs in the preview mode, the control unit 110 detects the occurrence of the record mode in step 427 and informs the image processing control unit 200 of the fact that the record mode occurs. Accordingly, the image processing control unit 200 operates the image CODEC 250 and returns to step 317 so as to store a newly photographed image in the memory 270. At this time, the image processing control unit 200 must store a newly photographed image subsequently to the image photographed and stored before the incoming call processing. Accordingly, as described above, the image CODEC 250 codes a first stored image frame as an I-frame and stores the coded image frame. Also, when the incoming call processing is terminated, if a user issues a record termination command, the image processing control unit 200 determines whether or not the image processing control unit 200 stores a file of a photographed moving picture in step 331.

When the incoming call is processed in the procedure shown in FIG. 4, image storage pauses while the incoming call is being processed. If the image photographing mode is re-performed after the incoming call processing, two or more files of images photographed when the incoming call is processed can be stored as one file.

If the image photographing mode is performed in the procedures shown in FIGS. 3 and 4, and if an incoming call is generated during the photographing the an image, the portable terminal informs the side originating the call of the fact that an image is being photographed and can terminate the incoming call processing. Accordingly, a user can continuously perform the image photographing mode. Also, when the incoming call is generated during the photographing of the image and the incoming call is processed, image files before and after the incoming call processing can be stored as one file. Also, when the incoming call is generated during the photographing of an image and the incoming call is processed, an image file stored before the incoming call processing can be stored after the incoming call processing.

Although the procedures shown in FIGS. 3 and 4 have been described on the assumption that a moving picture is photographed, the incoming call can be processed in a mode for photographing a still picture in the same manner. That is, when the incoming call is generated in the mode of photographing a still picture, it is guided that an image is being photographed by performing the voice guide function and an image photographing operation can be performed. In detail, when the incoming call is generated during the photographing of the still picture, the control unit 110 detects the generation of the incoming call, outputs a message guiding that the still picture is being photographed, terminates the incoming call processing, and then, continuously performs the image photographing mode.

As described above, according to embodiments of the present invention, a camera can continuously photograph an image even though an incoming call is generated in an image photographing mode in a portable terminal. When the incoming call is generated in the image photographing mode and processed, an image file after the incoming call is stored subsequently to an image file before the incoming call so that one image file can be made. Also, when the incoming call is generated in the image photographing mode and processed, a image file stored before the incoming call processing can be stored after the incoming call processing.

While the invention has been shown and described with reference to certain preferred embodiments thereof, it will be understood by those skilled in the art that various changes in form and details may be made therein without departing from the spirit and scope of the invention. Consequently, the scope of the invention should not be limited to the embodiments, but should be defined by the appended claims and equivalents thereof.

1. A method for processing an incoming call in a portable terminal including a camera, the method comprising the steps of:
storing an image photographed by the camera in an image storage mode;
generating a soundless alarm with respect to the generation of the incoming call when the incoming call is generated in an image photographing mode and maintaining the image storage mode;
generating a message that a response to the incoming call cannot be performed when an incoming call holding command is issued in the step of generating the soundless alarm, terminating an incoming call processing, and maintaining the image storage mode; and
controlling an input of a name of a stored image file when a record termination command is issued in the image storage mode and storing the file name with the stored image file after the file name is input.

2. The method as claimed in claim 1, wherein the soundless alarm is generated by lighting a lamp in the step of generating the soundless alarm, and originating call subscriber information is displayed on a display unit.

3. The method as claimed in claim 2, wherein the incoming call holding command is issued due to signal generation of an incoming call holding key.

4. The method as claimed in claim 2, wherein the incoming call holding command is issued if a response command for the incoming call is not issued during a predetermined time after the generation of the incoming call.

5. The method as claimed in claim 1, further comprising a step of generating a message that a response to the incoming call cannot be performed if establishment of a call rejection function is detected in the step of generating the soundless alarm, terminating the incoming processing, and maintaining the image photographing mode.

6. The method as claimed in claim 5, wherein the incoming call is generated through a voice or a message.

7. A method for photographing a moving picture in a portable terminal including a camera and an image processing unit which processes an image photographed by the camera, the method comprising the steps of:
performing a preview mode for displaying the image photographed by the camera when the camera is operated;
performing an image storage mode for coding the image photographed by the camera and storing the coded image in an image memory when a moving picture storage key is input in the preview mode;
performing an incoming call processing mode after storing the moving picture stored in the image memory as a moving picture file when an incoming call is generated in the image storage mode and returning to the preview mode when the incoming call processing is terminated; and
creating and storing one file by linking moving picture files stored in the image memory when a record end key is input.

8. The method as claimed in claim 7, wherein the call is generated through a voice or a message.

9. The method as claimed in claim 8, wherein the step of processing the incoming call in the image storage mode further includes the steps of:
generating a soundless alarm when the incoming call is generated in the image storage mode and displaying information regarding a call originating subscriber;
processing the incoming call after storing the moving picture stored in the image memory as a moving picture file if an incoming call processing is selected and returning to the preview mode when the incoming call processing is terminated; and
terminating the incoming call processing and maintaining the image storage mode if the incoming call processing is rejected.

10. The method as claimed in claim 9, wherein the step of generating the soundless alarm further includes a step of indicating generation of the incoming call by lighting a lamp and generating a message that a response to the incoming call cannot be performed by giving a previously recorded voice message to the originating call subscriber when the incoming call is rejected.

11. The method as claimed in claim 10, wherein the step of performing the moving picture storage mode further comprises a step of generating a message that the response to the incoming call cannot be performed by giving the previously recorded voice message to the call originating subscriber if a voice guide function is established in the moving picture storage mode and continuously performing the moving picture storage mode.

12. A portable terminal apparatus comprising:
a radio frequency unit and data processing unit for receiving incoming calls and transmitting outgoing calls;
a camera for photographing subjects;
an image processing unit for processing images received from said camera and said data processing unit;
a memory for storing image data and other data;
a voice synthesizing unit; and
a control unit for controlling the operations of said portable terminal, wherein if an incoming call is generated during the photographing the an image, said control unit performs operations to inform the side originating the call of the fact that an image is being photographed and can terminate processing of the incoming call.

13. The apparatus of claim 12, wherein when said incoming call is generated during the photographing of the image and said incoming call is processed, image files before and after processing the incoming call can be stored as one file in said memory.

14. The apparatus of claim 13, wherein when said incoming call is generated during the photographing of an image and said incoming call is processed, an image file stored before processing said incoming call can be stored in said memory after processing said incoming call.
